(19) United States
(12) Patent Application Publication
(10) Pub. No.: US 2020/0400448 A1
(43) Pub. Date: Dec. 24, 2020

(54) RIDE-SHARING MANAGEMENT DEVICE, RIDE-SHARING MANAGEMENT METHOD, AND RECORDING MEDIUM

(71) Applicant: HONDA MOTOR CO., LTD., Tokyo (JP)

(72) Inventor: Megumi Yanaga, Wako-shi (JP)

(21) Appl. No.: 16/902,298

(22) Filed: Jun. 16, 2020

(30) Foreign Application Priority Data
Jun. 20, 2019 (JP) 2019-114513

(51) Int. Cl. G01C 21/34; G01C 21/36

(52) U.S. Cl. CPC G01C 21/3438; G01C 21/3617; G01C 21/3484

(57) ABSTRACT

A ride-sharing management device includes an operation plan generating part configured to generate an operation plan for one or more shared vehicles on the basis of a ride request from a user, and an acquisition part configured to acquire from a first user impression information regarding a second user who has boarded the shared vehicle together with the first user, and the operation plan generating part determines a user who boards the shared vehicle together with the first user on the basis of the impression information acquired by the acquisition part.

### CROSS-REFERENCE TO RELATED APPLICATION

Priority is claimed on Japanese Patent Application No. 2019-114513, filed Jun. 20, 2019, the content of which is incorporated herein by reference.

### BACKGROUND OF THE INVENTION

### Field of the Invention

The present invention relates to a ride-sharing management device, a ride-sharing management method, and a recording medium.

### Description of Related Art

In the related art, a technology which realizes a ride-sharing service in which requirements for sharing vehicles are matched is known (for example, see Japanese Unexamined Patent Application, First Publication No. 2018-205829).

### SUMMARY OF THE INVENTION

Incidentally, there may be significant opportunities for a user who habitually uses a shared vehicle that is allocated by a ride-sharing service such as for commuting, attending school, or the like, to board the same shared vehicle as occupants with similar habits. Here, if an occupant who boards the same shared vehicle is a person who performs an undesired behavior or makes undesired remarks, the user may desire that he/she does not want to board the same shared vehicle as the occupant. However, in the related art, it is not possible to determine an occupant who will board the same shared vehicle according to the user's impression thereof.

An aspect of the present invention is directed to providing a ride-sharing management device, a ride-sharing management method, and a recording medium that are capable of determining an occupant who will board the same shared vehicle according to a user's impression.

A ride-sharing management device, a ride-sharing management method, and a recording medium according to the present invention employ the following configurations.

(1) A ride-sharing management device according to an aspect of the present invention includes an operation plan generating part configured to generate an operation plan for one or more shared vehicles on the basis of a ride request from a user; and an acquisition part configured to acquire from a first user impression information regarding a second user who has boarded the shared vehicle together with the first user, wherein the operation plan generating part determines a user who will board the shared vehicle together with the first user on the basis of the impression information acquired by the acquisition part.

(2) In the ride-sharing management device according to the aspect of the above-mentioned (1), the impression information may be information generated according to a format that describes complaints with respect to the second user.

(3) In the ride-sharing management device according to the aspect of the above-mentioned (1) or (2), the operation plan generating part may generate the operation plan on the basis of the impression information.

(4) In the ride-sharing management device according to any one aspect of the above-mentioned (1) to (3), the operation plan generating part may determine a combination such that the first user and the second user do not board the same shared vehicle when the impression information is negative contents equivalent to or more than a first criterion in a case in which the first user boards the shared vehicle.

(5) In the ride-sharing management device according to any one of the above-mentioned (1) to (4), the operation plan generating part may generate the operation plan such that the first user and the second user do not sit on next seats when the impression information is negative contents equivalent to or more than a second criterion in a case in which the first user and the second user board the same shared vehicle together.

(6) The ride-sharing management device according to any one aspect of the above-mentioned (1) to (5) may further include a notification control part configured to perform control for notification that the second user will board the shared vehicle together with the first user when the operation plan generated by the operation plan generating part shows that the first user and the second user will board the same shared vehicle together.

(7) A ride-sharing management method according to another aspect of the present invention is performed by a computer, the method including: generating an operation plan for one or more shared vehicles on the basis of a ride request from a user; acquiring from a first user impression information regarding a second user who has boarded the shared vehicle together with the first user; and determining a user who will board the shared vehicle together with the first user on the basis of the acquired impression information.

(8) A recording medium according to another aspect of the present invention on which a program is stored and executed by a computer, the program including: generating an operation plan for one or more shared vehicles on the basis of a ride request from a user; acquiring from a first user impression information regarding a second user who has boarded the shared vehicle together with the first user; and determining a user who will board the shared vehicle together with the first user on the basis of the acquired impression information.

According to the aspect of the above-mentioned (1) to (8), an occupant who boards the same shared vehicle can be determined according to impression of a user.

### BRIEF DESCRIPTION OF THE DRAWINGS

FIG. 1 is a view showing an example of a configuration of a ride-sharing management system including a ride-sharing management device according to an embodiment.

FIG. 2 is a view showing an example of a first operation image displayed on the display device of the terminal device when a user performs an operation of transmitting a ride request.

FIG. 3 is a view showing an example of details of a ride request.

FIG. 4 is a view showing an example of a second operation image displayed on the display device of the terminal device when a user performs an operation of transmitting impression information.

FIG. 5 is a view showing an example of a third operation image displayed on the display device of the terminal device when a user performs an operation of transmitting impression information.

FIG. 6 is a view showing an example of details of impression information.

FIG. 7 is a view showing an example of a configuration of the ride-sharing management device.

FIG. 8 is a view showing an example of details of operation plan information.

FIG. 9 is a view showing an example of details of unified impression information.

FIG. 10 is a view for describing processing of determining a fellow passenger.

FIG. 11 is a view showing an example of a notification image notifying that a second user will also be riding.

FIG. 12 is a view showing an example of a scene where a user's seat is specified.

FIG. 13 is a flowchart showing an example of a flow of processing of generating unified impression information.

FIG. 14 is a flowchart showing an example of a flow of processing of determining a fellow passenger in a shared vehicle.

FIG. 15 shows information representing an example of details of first user impression information.

### DETAILED DESCRIPTION OF THE INVENTION

### Embodiment

Hereinafter, embodiments of a ride-sharing management device, a ride-sharing management method, and a program of the present invention will be described with reference to the accompanying drawings.

### Summary of Ride-Sharing Management System 1

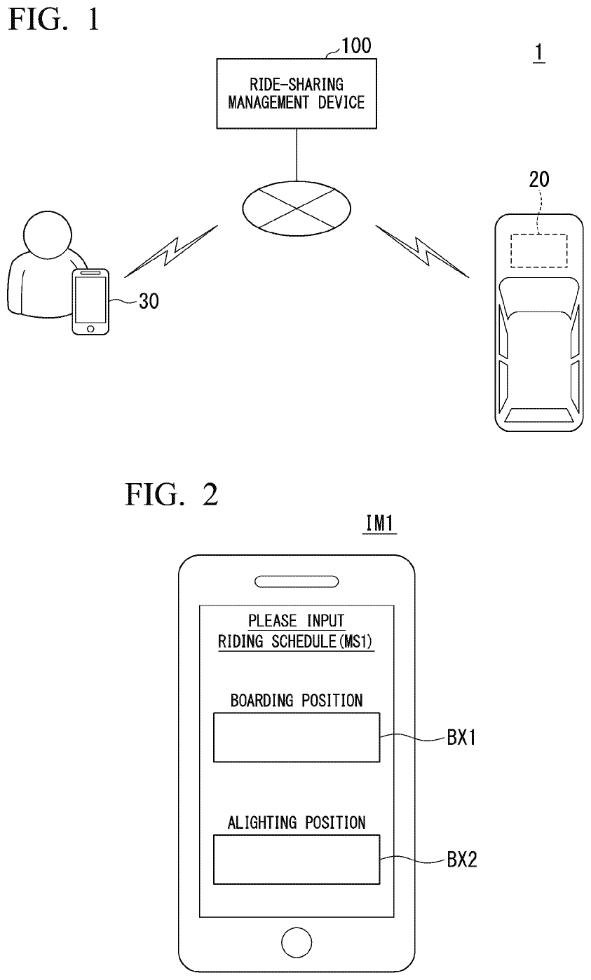

FIG. 1 is a view showing an example of a configuration of a ride-sharing management system 1 including a ride-sharing management device 100 according to an embodiment. The ride-sharing management system 1 includes, for example, the ride-sharing management device 100, one or more vehicle control devices 20, and one or more terminal devices 30. The ride-sharing management device 100, the vehicle control device 20 and the terminal device 30 are able to communicate with each other via a network NW. The network NW includes a cellular network, a Wi-Fi network, the Internet, a wide area network (WAN), a local area network (LAN), a public communication line, a provider device, a private line, a radio base station, or the like. In addition, these components may directly perform wireless communication without a network NW interposed therebetween.

The ride-sharing management device 100 manages boarding of a vehicle used for a ride-sharing service (hereinafter, a shared vehicle M). In the ride-sharing, unknown users may board the same shared vehicle M (ride together). Hereinafter, allocating a plurality of users to one shared vehicle M is referred to as matching. The ride-sharing management device 100 matches an owner of the shared vehicle M, a driver, or a user who is to board the shared vehicle M as a moving means, and determines a user who will board the shared vehicle M. In addition, the ride-sharing management device 100 generates an operation plan and transmits the operation plan to the shared vehicle M on the basis of a boarding position, an alighting position, and a destination of a user who boards the determined shared vehicle M. In the following description, when the owner and the driver of the shared vehicle M are not distinguished from each other, the owner and the driver are referred to as “an owner of the shared vehicle M” and a user of the ride-sharing service (the shared vehicle M) is simply referred to as “a user.”

Hereinafter, the case in which the shared vehicle M is an automatically driven vehicle will be described. “A driver” may not be present when the shared vehicle M is an automated driving vehicle. The vehicle control device 20 in the case of the automated driving vehicle performs driving control by automatically controlling steering, acceleration and deceleration of the shared vehicle M on the basis of recognition results recognized by the recognition parts using outputs of a camera, a radar device, a LIDAR, or the like, provided in the shared vehicle M. For example, the vehicle control device 20 may control and drive the shared vehicle M on the basis of the operation plan when information showing the operation plan is received from the ride-sharing management device 100. The operation plan is, for example, information showing a traveling route of the shared vehicle M, a position of an occupant who boards the shared vehicle M, a position of an occupant who alights from the shared vehicle M, an estimated time when an occupant boards and alights, and the like. Further, driving control of the shared vehicle M may be performed by manual operations of a driver. In this case, the vehicle control device 20 presents information showing the operation plan received from the ride-sharing management device 100 to a driver using a display device or the like provided in the shared vehicle M. Hereinafter, the case in which the shared vehicle M is an automated driving vehicle will be described.

The terminal device 30 is a terminal device owned by a user such as a smartphone, a tablet terminal, a personal terminal, or the like. The terminal device 30 transmits a ride request 32 to the shared vehicle M or information showing impression to another user who boards together (hereinafter, impression information 34) to the ride-sharing management device 100 on the basis of the operation of the user.

FIG. 2 is a view showing an example of a first operation image IM1 displayed on a display device of the terminal device 30 when a user performs an operation of transmitting the ride request 32. The first operation image IM1 includes, for example, a message MS1 that prompts a user to input information related to riding schedule to the shared vehicle M, a box BX1 to which a user inputs an address of a boarding position where the user will board the shared vehicle M, and a box BX2 to which a user inputs an address of an alighting position where a user will alight from the shared vehicle M. The message MS1 is a message, for example, “Please input riding schedule” or the like. The first operation image IM1 is displayed by a first user when an application or the like used when a user who is to board the shared vehicle M transmits the ride request 32 to the ride-sharing management device 100 is executed in the terminal device 30 or accesses a website that receives the ride request 32 using the terminal device 30.

Further, hereinabove, while the case in which the first operation image IM1 accepts a boarding position and an alighting position according to an address has been described, there is no limitation thereto. For example, the first operation image IM1 may accept a boarding position and an alighting position by displaying a map and designating the boarding position and the alighting position on the displayed map according to the user. In addition, the first operation image IM1 may accept coordinates of a boarding position and an alighting position.

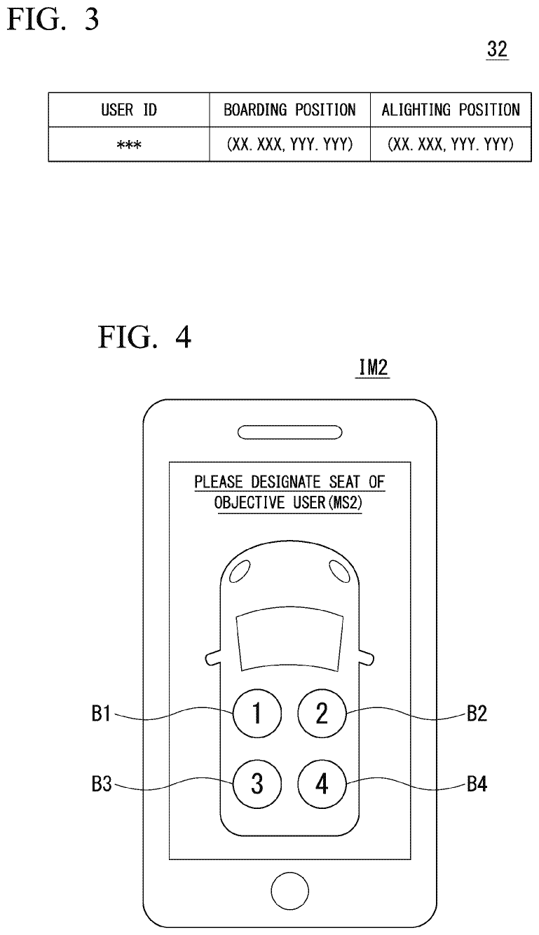

FIG. 3 is a view showing an example of details of the ride request 32. The ride request 32 is, for example, information in which pieces of information showing a user ID of a user who wishes to board the shared vehicle M, and a boarding position of the user and an alighting position of the user are associated with each other.

FIG. 4 is a view showing an example of a second operation image IM2 displayed on a display device of the terminal device 30 when a user performs an operation of transmitting the impression information 34. The terminal device 30 is, for example, a screen including a functional part configured to identify a position of a host vehicle such as a global navigation satellite system (GNSS) receiver and configured to be automatically displayed when a position of the terminal device 30 becomes an alighting position included in the ride request 32. The second operation image IM2 includes, for example, a message MS2 that urges a user to select other user which is an object that the user provides impression, and buttons (buttons B1 to B4 shown) configured to select positions (seats) of other users in the shared vehicle M. The message MS2 is a message such as “please designate a seat of other user as an object.” In the following description, a user who transmits (provides) the impression information 34 to the ride-sharing management device 100 is referred to as “a first user,” a user who is a user also boarding the shared vehicle M used by the first user and to whom the first user has felt impression (evaluated by the first user) according to the impression information 34 by the first user is referred to as “a second user,” and the user is simply referred to as “a user” when the first user and the second user are not discriminated.

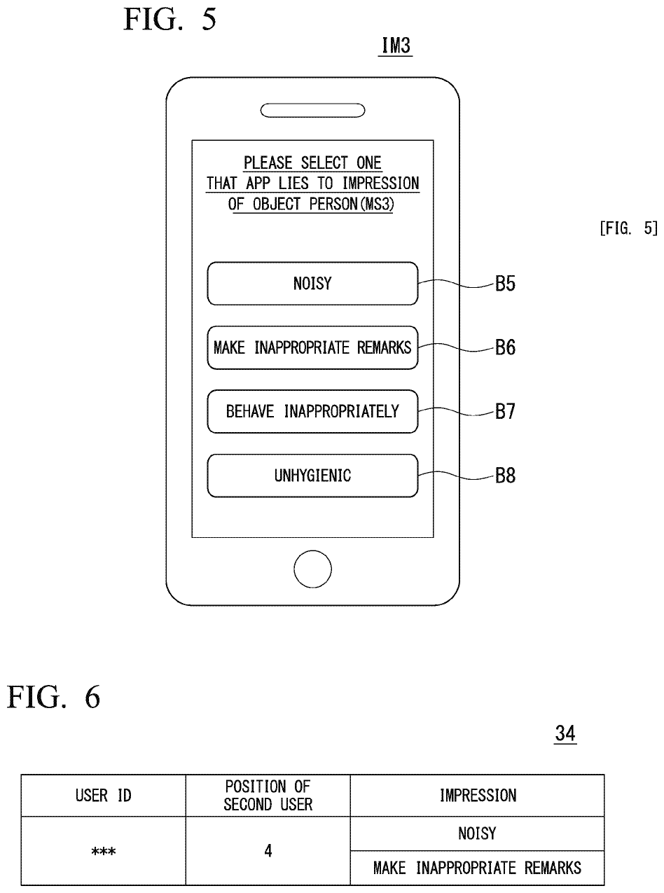

FIG. 5 is a view showing an example of a third operation image IM3 displayed on the display device of the terminal device 30 when a user performs an operation of transmitting the impression information 34. The third operation image IM3 is, for example, a screen displayed when a first user selects a position of a second user to whom the first user has felt impression in the second operation image IM2. The third operation image IM3 includes buttons (buttons B5 to B8 shown) configured to select complaints that apply as impression of a second user, and a message MS3 that urges selection of alternatives related to the complaints. The message MS3 is a message, for example, “please select one that applies to impression of an object person” or the like. Alternatives shown by the buttons B5 to B8 are, for example, “a second user is noisy,” “a second user makes inappropriate remarks,” “a second user behaves inappropriately,” “a second user is unhygienic,” and the like. Complaints are an example of “negative contents,” and the third operation image IM3 is an example of “a format that describes complaints about the second user.”

Further, the alternatives included in the third operation image IM3 are examples and not limited thereto, and the third operation image IM3 may also include alternatives of impression that praises the second user, in addition to alternatives related to complaints. In addition, in the above-mentioned description, while the case of providing complaints related to the second user by causing the first user to select the applicable one from alternatives indicating the complaints related to the second user has been described, there is no limitation thereto. The third operation image IM3 may include, for example, a comment box in which a first user describes impression (comments) of a second user. In this case, the first user operates the terminal device 30 and inputs the comments related to the second user into the comment box. Then, the terminal device 30 generates the impression information 34 including information showing comments input into the comment box as the information showing the impression included in the impression information 34.

In addition, in the above-mentioned description, while the case in which the second operation image IM2 is automatically displayed when it is detected that the first user uses the shared vehicle M and alights from the shared vehicle M has been described, there is no limitation thereto. The second operation image IM2 may be displayed when the first user executes an application to provide an impression regarding the second user who has also boarded the shared vehicle M on the terminal device 30 or accesses a website using the terminal device 30 which receives the impression.

The terminal device 30 generates the impression information 34 and transmits the impression information 34 to the ride-sharing management device 100 on the basis of the operation performed with respect to the second operation image IM2 or the third operation image IM3 by the user. FIG. 6 is a view showing an example of details of the impression information 34. The impression information 34 is, for example, information in which information showing a user ID of a first user, information showing a position of a second user in the shared vehicle M (in this case, the number corresponding to the position of the seat) and information showing the selected impression, are coordinated to each other.

Here, a user may not wish to ride in the shared vehicle M in the future with other users to whom a poor impression was held. Therefore, the ride-sharing management device 100 determines a fellow passenger in consideration of impression of users.

### Configuration of Ride-Sharing Management Device 100

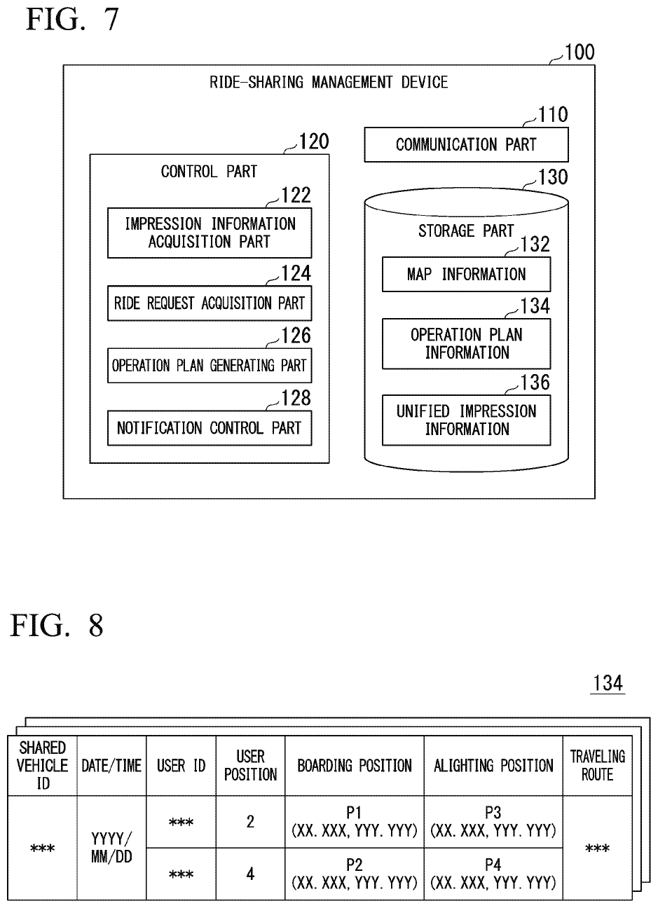

FIG. 7 is a view showing an example of a configuration of the ride-sharing management device 100. The ride-sharing management device 100 includes, for example, a communication part 110, a control part 120, and a storage part 130.

The communication part 110 receives, for example, a ride request or the impression information 34 from the terminal device 30. In addition, the communication part 110 transmits information showing an operation plan generated by the control part 120 to the vehicle control device 20.

The control part 120 includes, for example, an impression information acquisition part 122, a ride request acquisition part 124, an operation plan generating part 126, and a notification control part 128. These components are realized by executing a program (software) stored in the storage part 130 using a processor, for example, a central processing unit (CPU) or the like. In addition, some or all of these components may be realized by hardware (a circuit part; including circuitry) such as a large scale integration (LSI), an application specific integrated circuit (ASIC), a field-programmable gate array (FPGA), a graphics processing unit (GPU), or the like, or may be realized by cooperation of software and hardware.

The storage part 130 may be realized by a storage device (a storage device including a non-transient recording medium) such as a hard disk drive (HDD), a flash memory, or the like, may be realized by a detachable recording medium (a non-transient recording medium) such as a DVD, a CD-ROM, or the like, or may be a recording medium mounted on a drive device. In addition, a part of or the entire storage part 130 may be an external device, to which the ride-sharing management device 100 is accessible, such as an NAS, an external storage server, or the like. For example, in addition to the above-mentioned program, information such as map information 132, operation plan information 134, unified impression information 136, and the like, is stored in the storage part 130. The map information 132 is used, for example, when the control part 120 generates an operation plan of the shared vehicle M. The map information 132 is, for example, information in which a road shape is expressed by a link showing a road and nodes connected by the link. The map information 132 may include a curvature of a road, point of interest (POI) information, or the like. The unified impression information 136 will be described below in detail.

The impression information acquisition part 122 receives (acquires) the impression information 34 from the terminal device 30 using the communication part 110. The impression information acquisition part 122 generates (updates) the unified impression information 136 that integrates the impression information 34 for each second user on the basis of the impression information 34 and the operation plan information 134, which are acquired.

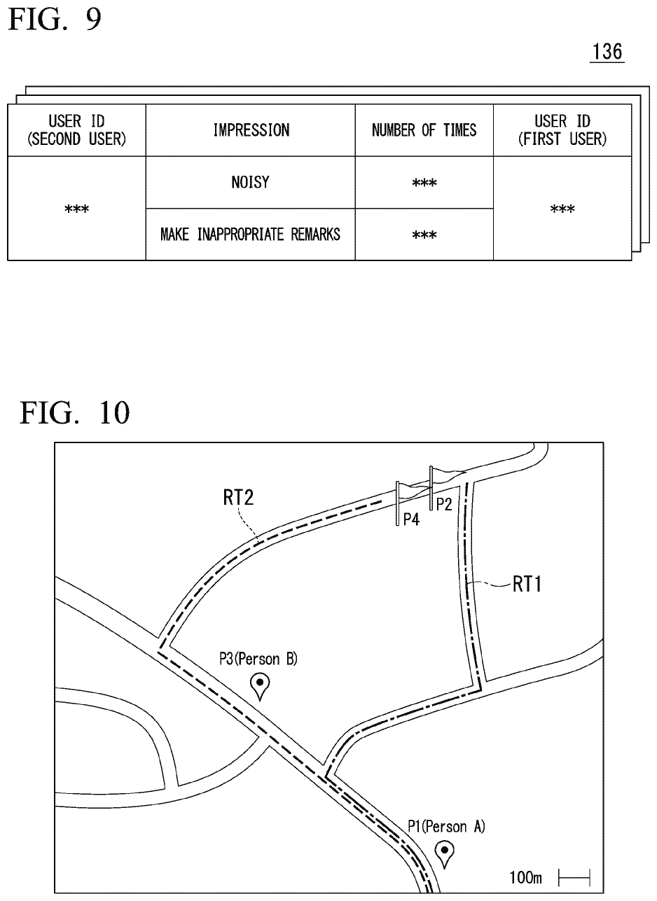

FIG. 8 is a view showing an example of details of the operation plan information 134. The operation plan information 134 is, for example, information in which an ID that can identify the shared vehicle M used in a ride-sharing service (hereinafter, a shared vehicle ID), information showing a date and time when the shared vehicle M is used in the ride-sharing service, a user ID of a user who boards the shared vehicle M together, a boarding position and an alighting position of the user of the user ID, and information showing a traveling route of the shared vehicle M, are coordinated to each other. For example, the operation plan information 134 is generated (updated) whenever an operation plan is generated by the operation plan generating part 126, which will be described below. FIG. 9 is a view showing an example of details of the unified impression information 136. The unified impression information 136 is, for example, information including one or more records in which a user ID of a second user, information showing impression of the second user held by one or more first users (evaluated by one or more first users), information showing the number of times the second user has received impressions from one or more first users, and an user ID of one or more first users that have provided impressions related to the second user, are coordinated to each other for each second user.

First, the impression information acquisition part 122 searches the operation plan information 134 using a user ID of a first user included in the acquired impression information 34 as a search key, and specifies one or more second users who board the shared vehicle M together used by the first user. Next, the impression information acquisition part 122 specifies a second user who has been received impression from the first user among one or more specified second users, on the basis of the position of the second user included in the acquired impression information 34. Then, the impression information acquisition part 122 adds information showing impression included in the acquired impression information 34 and a user ID of the first user who has provided the impression information 34 to the record of the specified second user among the record included in the unified impression information 136. Accordingly, the impression information acquisition part 122 can generate the unified impression information 136 that integrates the impression information 34 related to the second user even when the first user does not know personal information of the second user.

Further, when a second user can acquire a user ID of a first user, the terminal device 30 may generate the impression information 34 including the user ID of the first user instead of the information showing a position of the second user contained in the impression information 34. A case where the second user can acquire the user ID of the first user is, for example, a case in which an image showing the user ID of the fellow passenger of the shared vehicle M is displayed on the display device included in the vehicle control device 20 or the display device of the terminal device 30. In this case, in the second operation image IM2, the terminal device 30 does not receive the operation of specifying the position of the second user, and receives input of the user ID of the second user. Accordingly, the impression information acquisition part 122 can generate the unified impression information 136 without using the operation plan information 134.

Further, among the total number of the impressions of second user held by the one or more first users, the unified impression information 136 may include a proportion of the numbers for each certain impressions.

The ride request acquisition part 124 receives (acquires) the ride request 32 transmitted by a user using the terminal device 30 from the communication part 110.

The operation plan generating part 126 generates an operation plan on the basis of the map information 132 and the operation plan information 134 according to the ride request 32 acquired by the ride request acquisition part 124. First, the operation plan generating part 126 determines a shared vehicle M that is the shared vehicle M present in the vicinity of the boarding position of the user shown by the ride request 32 acquired by the ride request acquisition part 124 and planned to travel in a direction to the alighting position of the user shown by the ride request 32 or a shared vehicle M not planned to be used in the ride-sharing service at the moment, as the shared vehicle M to which the user will board on. Next, the operation plan generating part 126 determines a traveling route from a boarding position to an alighting position of a user shown by the ride request 32 on the basis of the map information 132. The operation plan generating part 126 transmits the information showing the generated operation plan related to the shared vehicle M to the vehicle control device 20, and generates (updates) the operation plan information 134 according to the operation plan.

In addition, the operation plan generating part 126 basically determines a candidate for a fellow passenger as a fellow passenger of the shared vehicle M when the ride request 32 is acquired from a user (hereinafter, a candidate of a fellow passenger) who desires movement on a route that coincides with the traveling route by the ride request acquisition part 124 in the vicinity of the determined traveling route. However, even though the traveling routes match on the basis of the unified impression information 136, the operation plan generating part 126 determines a combination of fellow passengers such that candidates for fellow passengers do not board the shared vehicle M of the user (condition 1) when the user and the candidates for fellow passengers are a first user and a second user who have received complaints as the impression information 34 from the first user or (condition 2) when the candidate of the fellow passenger is the second user who has received complaints equivalent to or more than a first criterion from the users. In addition, the operation plan generating part 126 determines (condition 3), when the candidate of the fellow passenger is the second user who has received complaints less than a first criterion and equivalent to or more than a second criterion from the users, a combination of the fellow passengers such that the candidate of the fellow passenger does not sit on a seat next to the user even though the candidate of the fellow passenger boards the same shared vehicle M of the user.

### With Respect to (Condition 1)

The operation plan generating part 126 searches the unified impression information 136 using a user ID of a user or a user ID of a candidate of a fellow passenger as a search key when the ride request 32 from the candidate of the fellow passenger is acquired by the ride request acquisition part 124 in the vicinity of the determined traveling route. As a result of search, the operation plan generating part 126 determines whether a record in which a user ID of a user is coordinated to a user ID of the first user and a user ID of a candidate of a fellow passenger is coordinated to a user ID of the second user. When the operation plan generating part 126 determines that the record is present, the operation plan generating part 126 considers that the user has felt complaints with respect to the candidate of the fellow passenger in the past, and determines a combination of fellow passengers such that the candidate of the fellow passenger does not board the shared vehicle M of the user even when the ride request 32 is acquired from the candidate of the fellow passenger.

### With Respect to (Condition 2)

The operation plan generating part 126 determines whether the candidate of the fellow passenger is the second user who has received the complaints equivalent to or more than the first criterion when the ride request 32 from the candidate of the fellow passenger is acquired by the ride request acquisition part 124 in the vicinity of the determined traveling route. Having received the complaints equivalent to or more than the first criterion means, for example, (1) being provided the impression information 34 related to the complaints from the first user equivalent to or more than a first predetermined number of people, (2) being provided the impression information 34 related to the complaints equivalent to or more than a first predetermined number of times, (3) being provided the impression information 34 for equivalent to or more than a first predetermined number of types of complaints, or the like. The operation plan generating part 126 determines, for example, a record related to the candidate of the fellow passenger by searching the unified impression information 136 using the user ID of the candidate of the fellow passenger as a search key. Then, the operation plan generating part 126 determines that the candidate of the fellow passenger is the second user who has received the complaints equivalent to or more than the first criterion and determines a combination of the fellow passengers such that the candidate of the fellow passenger does not board the shared vehicle M of the user together when the specified record satisfies at least one of conditions (1) to (3).

### With Respect to (Condition 3)

The operation plan generating part 126 determines whether the candidate of the fellow passenger is the second user who has received the complaints less than the first criterion and equivalent to or more than the second criterion when the ride request 32 from the candidate of the fellow passenger is acquired by the ride request acquisition part 124 in the vicinity of the determined traveling route. Having received the complaints equivalent to or more than the second criterion means, for example, (4) being provided the impression information 34 related to the complaints from the first user equivalent to or more than a second predetermined number of people, (5) being provided the impression information 34 related to the complaints equivalent to or more than a second predetermined number of times, (6) being provided the impression information 34 for equivalent to or more than a second predetermined number of types of complaints, or the like. Here, the first predetermined number of people is greater than the second predetermined number of people, the first predetermined number of times is greater than the second predetermined number of times, and the first predetermined number is greater than the second predetermined number. Accordingly, the first criterion is a criterion that is stricter (higher degree of complaints) than the second criterion. The operation plan generating part 126 specifies, for example, the record related to the candidate of the fellow passenger by searching the unified impression information 136 using the user ID of the candidate of the fellow passenger as a search key. Then, the operation plan generating part 126 determines that the candidate of the fellow passenger is the second user who has received the complaints equivalent to or more than the second criterion when the specified record satisfies at least one of conditions (4) to (6), and determines a combination of the fellow passengers such that the candidate of the fellow passenger does not sit on the seat next to the user even when the candidate boards the shared vehicle M of the user together.

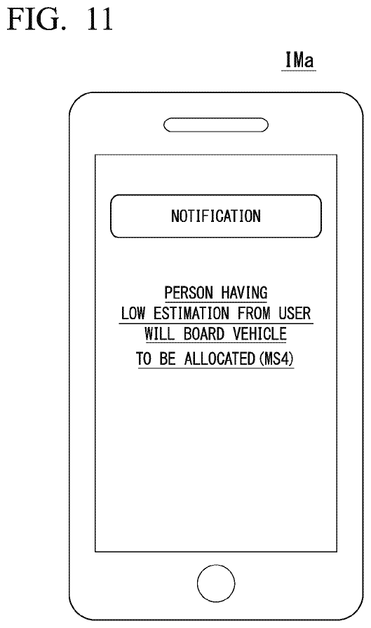

FIG. 10 is a view for describing processing of determining a fellow passenger. In FIG. 10, there is a user who plans to move from a position P1 to a position P2 (hereinafter, Person A) and a user who plans to move from a position P3 to a position P4 (hereinafter, Person B). In addition, a distance from the position P2 to the position P4, which are destinations of two persons, is short. In addition, the shared vehicle M is present in the vicinity of Person A.

The ride request acquisition part 124 acquires the ride request 32 from Person A and Person B. In this case, for Person A, Person A is a user one self, and Person B is a candidate of a fellow passenger. In addition, for Person B, Person B is a user one self, and Person A is a candidate of a fellow passenger. Hereinafter, the case in which Person A is the user and Person B is the candidate of the fellow passenger will be described. Further, in the case in which Person B is the user and Person A is the candidate of the fellow passenger, “Person A” and “Person B” may be read by replacing “Person B” and “Person A”, respectively.

The operation plan generating part 126 generates an operation plan related to movement of Person A on the basis of the ride request 32 of Person A. For example, a traveling route RT1 bypassing rightward and a traveling route RT2 bypassing leftward are present in candidates of a traveling route in the operation plan. The operation plan generating part 126 determines whether a user who desires transport of a route that coincides with the determined traveling route RT1 or the determined traveling route RT2 (i.e., a candidate of a fellow passenger of the shared vehicle M) is present. As described above, in this case, the operation plan generating part 126 determines that Person B is a candidate of a fellow passenger.

The operation plan generating part 126 determines whether Person B (a candidate of a fellow passenger) satisfies any one of (condition 1) to (condition 3) on the basis of the unified impression information 136. The operation plan generating part 126 determines a combination of fellow passengers such that Person B does not board the shared vehicle M used by Person A (a user) when Person B satisfies (condition 1) and/or (condition 2). In this case, the operation plan generating part 126 generates an operation plan by determining the traveling route RT1 as a route along which the shared vehicle M travels. In addition, the operation plan generating part 126 generates an operation plan in which the shared vehicle M does not stop at the position P3 where Person B boards even when the traveling route RT2 is determined as a route along which the shared vehicle M travels. In addition, when Person B satisfies (condition 3), the operation plan generating part 126 generates an operation plan by determining combination of fellow passengers such that Person B does not sit on a seat next to Person A even though Person B boards the shared vehicle M of the user together. In this case, the operation plan generating part 126 determines the traveling route RT2 as a route along which the shared vehicle M travels.

The operation plan generating part 126 generates an operation plan by determining a fellow passenger of the shared vehicle M, a position of the fellow passenger in the shared vehicle M, a boarding position and an alighting position of a user of the shared vehicle M, and a traveling route of the shared vehicle M. The operation plan generating part 126 updates the operation plan information 134 according to the operation plan while transmitting the information showing the generated operation plan to the objective shared vehicle M through the communication part 110.

Further, the operation plan generating part 126 may transmit the information showing the generated operation plan to the terminal device 30 of the user who boards the objective shared vehicle M. Accordingly, the operation plan generating part 126 can allow a user who boards the shared vehicle M to understand a traveling route, a transit point, or the like, of the shared vehicle M.

Returning to FIG. 7, the notification control part 128 controls notification to the fellow passenger of the second user that the second user will board the shared vehicle M together when the operation plan generated by the operation plan generating part 126 shows that the second user boards the same shared vehicle M together. FIG. 11 is a view showing an example of a notification image IMa notifying that the second user boards the shared vehicle together. The notification image IMa includes, for example, a message MS4 notifying a user that the second user boards the shared vehicle M together. The message MS4 is a message of, for example, “a person having low estimation from users will board a vehicle to be allocated” or the like. The notification control part 128 instructs the terminal device 30 to display, for example, the notification image IMa.

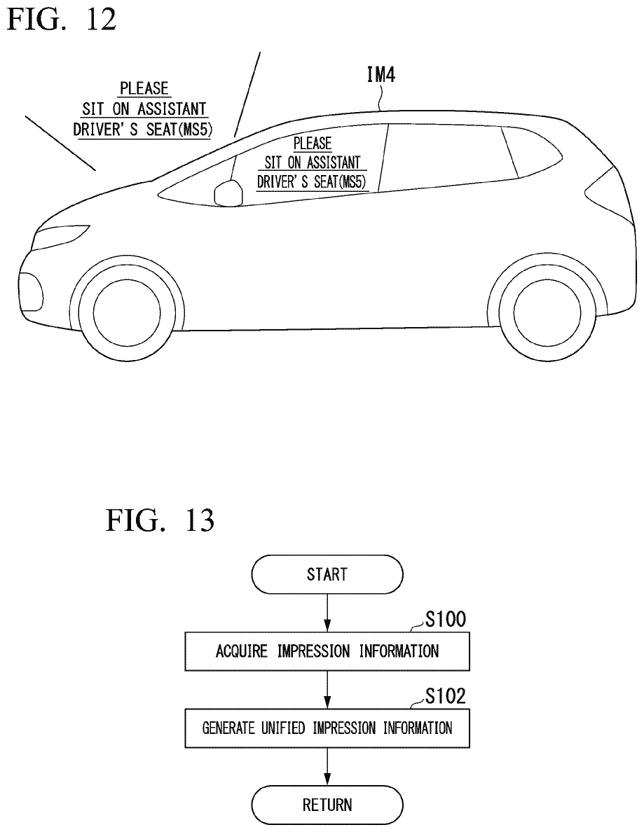

FIG. 12 is a view showing an example of a scene instructing a seat of a user. The notification control part 128 notifies a seat to the user who boards the shared vehicle M at the boarding position by using the notification function part included in the shared vehicle M on the basis of the operation plan generated by the operation plan generating part 126. The notification function part included in the shared vehicle M is realized by, for example, a speaker or a transparent liquid crystal display provided in a window of the shared vehicle M. In FIG. 12, the shared vehicle M outputs a message MS5 instructing a seat of a user from a speaker using a voice on the basis of the control of the notification control part 128. In addition, the shared vehicle M displays an image including the message MS5 on the transparent liquid crystal display on the basis of the control of the notification control part 128. The message MS5 is a message of, for example, “please sit on an assistant driver's seat” or the like. The notification control part 128 instructs the vehicle control device 20 so as to notify the message MS5 to the user, for example, at the timing when the shared vehicle M travels on the basis of the operation plan generated by the operation plan generating part 126, and it is specified by the function part (not shown), which is included in the shared vehicle M and configured to specify the position, that the shared vehicle M has arrived at a boarding position of the user.

Further, the above-mentioned notification function part included in the shared vehicle M is an example and not limited thereto. The notification control part 128 may perform notification of instructing a seat of a user by using the notification function part other than the speaker or the transparent liquid crystal display provided on the window of the shared vehicle M. In addition, the notification control part 128 may perform notification to at least one notification function part of one or more notification function parts provided in the shared vehicle M. In addition, the notification control part 128 may perform notification of instructing a seat of a user in a scene other than the scene in which the first user and the second user board the shared vehicle M together. In this case, for example, the notification control part 128 performs notification of instructing seats of users such that the users can easily board and alight from the shared vehicle M on the basis of the operation plan generated by the operation plan generating part 126.

### Operation Flow

FIG. 13 is a flowchart showing an example of a flow of processing of generating the unified impression information 136. First, the impression information acquisition part 122 acquires the impression information 34 from the terminal device 30 through the communication part 110 (step S100). Next, the impression information acquisition part 122 generates (updates) the unified impression information 136 that integrates the impression information 34 for each second user on the basis of the acquired impression information 34 and the operation plan information 134 (step S102).

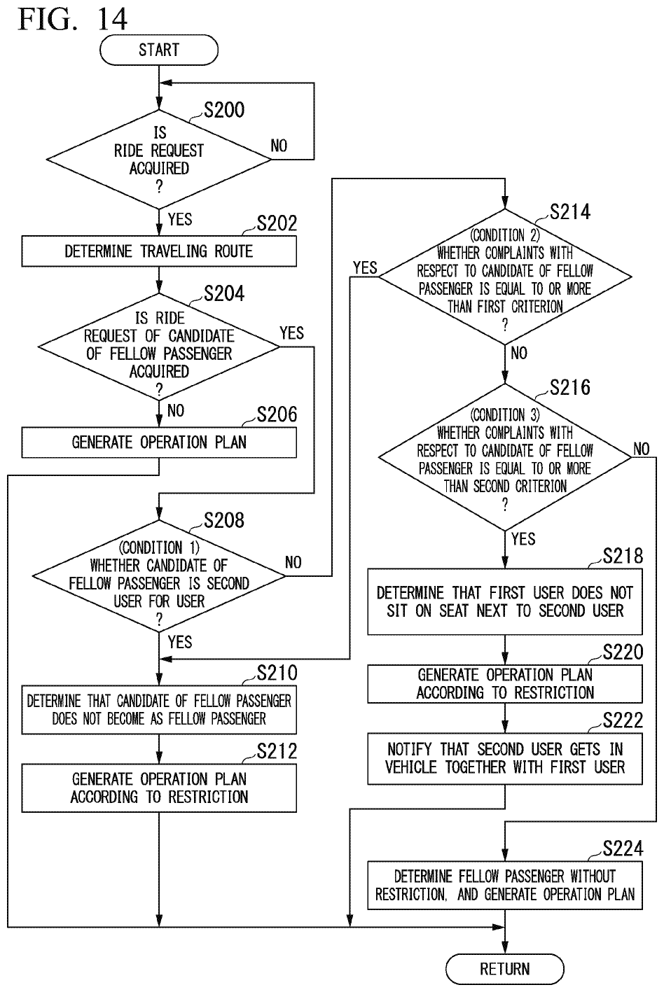

FIG. 14 is a flowchart showing an example of a flow of processing of determining a fellow passenger of the shared vehicle M. First, the ride request acquisition part 124 determines whether the ride request 32 is acquired from the user (step S200). The ride request acquisition part 124 waits until the ride request 32 is acquired from the user. The operation plan generating part 126 determines a traveling route along which a vehicle travels from a boarding position to an alighting position included in the ride request 32 when the ride request 32 is acquired by the ride request acquisition part 124 (step S202). Next, the operation plan generating part 126 determines whether the ride request 32 from the candidate of the fellow passenger is acquired in the vicinity of the traveling route determined by the ride request acquisition part 124 (step S204). The operation plan generating part 126 generates an operation plan corresponding to only the ride request 32 related to the user acquired in step S200 and transmits the operation plan to the vehicle control device 20 through the communication part 110 when the ride request 32 from the candidate of the fellow passenger is not acquired in the vicinity of the determined traveling route (step S206).

The operation plan generating part 126 determines whether the candidate of the fellow passenger is appropriate as the fellow passenger of the user when the ride request 32 from the candidate of the fellow passenger is acquired in the vicinity of the determined traveling route. First, the operation plan generating part 126 searches the unified impression information 136 using the user ID of the user and the user ID of the candidate of the fellow passenger as a search key, and determines whether a record in which the user ID of the user corresponds to a user ID of a first user and the user ID of the candidate of the fellow passenger corresponds to a user ID of a second user (step S208). When the operation plan generating part 126 determines that the record is present, the operation plan generating part 126 considers that the user has felt complaints with respect to the candidate of the fellow passenger in the past, and determines a combination of fellow passengers such that the candidate of the fellow passenger does not board the shared vehicle M of the user even when the ride request 32 is acquired from the candidate of the fellow passenger (step S210). Next, the operation plan generating part 126 generates an operation plan in which the candidate of the fellow passenger does not board the shared vehicle M of the user, and transmits the operation plan to the vehicle control device 20 through the communication part 110 (step S212).

When the operation plan generating part 126 determines that the record is not present, the operation plan generating part 126 determines whether the candidate of the fellow passenger is a second user who has received the complaints equivalent to or more than the first criterion (step S214). When the operation plan generating part 126 determines that the candidate of the fellow passenger is the second user who has received the complaints equivalent to or more than the first criterion, the operation plan generating part 126 determines a combination of fellow passengers such that the candidate of the fellow passenger does not board the shared vehicle M of the user (step S210).

When the operation plan generating part 126 determines that the candidate of the fellow passenger is not the second user who has received the complaints equivalent to or more than the first criterion, the operation plan generating part 126 determines whether the candidate of the fellow passenger is the second user who has received the complaints less than the first criterion and equivalent to or more than the second criterion (step S216). When the operation plan generating part 126 determines that the candidate of the fellow passenger is the second user who has received the complaints less than the first criterion and equivalent to or more than the second criterion, the operation plan generating part 126 determines a combination of fellow passengers such that the candidate of the fellow passenger does not sit on the seat next to the user even though the candidate of the fellow passenger boards the shared vehicle M of the user together (step S218). The operation plan generating part 126 generates an operation plan in which the candidate of the fellow passenger boards the shared vehicle M of the user together, and transmits the operation plan to the vehicle control device 20 through the communication part 110 (step S220). The notification control part 128 controls the notification to the fellow passenger of the second user that the second user will board the shared vehicle M together when the operation plan generated by the operation plan generating part 126 representing that the second user boards the same shared vehicle M together (step S222).

In the case in which the ride request 32 from the candidate of the fellow passenger is acquired in the vicinity of the determined traveling route, the operation plan generating part 126 determines a fellow passenger of a user without restrictions and generates an operation plan when the candidate of the fellow passenger is not the second user for the user, the candidate of the fellow passenger is not the second user who has received the complaints equivalent to or more than the first criterion, and the candidate of the fellow passenger is not the second user who has received the complaints equivalent to or more than the second criterion (step S224).

As described above, according to the ride-sharing management device 100 of the embodiment, it is possible to provide the ride-sharing service that considers users by determining an occupant who boards the same shared vehicle M according to impression of the users on the basis of the unified impression information 136 that integrates the impression information 34.

### When User is Neither First User Nor Second User

Further, the ride-sharing management device 100 may have a function part configured to consider a user who has not received complaints or received small complaints as a good user and provide a coupon (for example, a money-saving ticket or a discount ticket) related to a ride-sharing service to such good user when the user ID of the user acquired by the ride request 32 through the ride request acquisition part 124 is not contained in any record of the unified impression information 136 (i.e., when a user is neither a first user nor a second user). Accordingly, the ride-sharing management device 100 can urge the user to behave as a good user, and can smoothly operate the ride-sharing service because the user can be easily determined as a fellow passenger of the shared vehicle M as the number of good users increases.

### Variant

Hereinafter, a variant of the above-mentioned embodiment will be described. In the embodiment, the case in which the second user is determined as a fellow passenger of the first user according to the number of complaints or types of complaints the second user has received has been described. In the variant, the case in which the second user is determined as a fellow passenger of the first user according to the number of complaints or types of complaints held by the first user has been described. Further, the same components as the above-mentioned embodiment are designated by the same reference signs, and description thereof will be omitted.

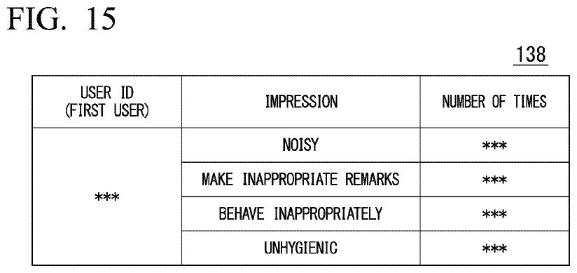

FIG. 15 is information showing an example of details of first user impression information 138. The first user impression information 138 is information including one or more of records for each of the first user in which, for example, a user ID of a first user who provides the impression information 34, information showing impression of the first user with respect to the second user, and the number of times of such impressions were provided by the first user, are coordinated with each other.

The impression information acquisition part 122 of the variant searches the first user impression information 138 using a user ID of a first user contained in the acquired impression information 34 as a search key, and specifies a record according to the first user. The impression information acquisition part 122 adds information showing the impression when the information showing the impression contained in the impression information 34 is not contained in the specified record. The impression information acquisition part 122 updates by adding “1” to the number of times corresponding to the information showing the impression when the information showing the impression contained in the impression information 34 is contained in the specified record. As described above, the impression information acquisition part 122 collects information related to the impression held by the first user, who has provided the impression information 34 regarding the second user, by generating (updating) the impression information acquisition part 122.

The operation plan generating part 126 of the variant determines a combination of fellow passengers such that a candidate of a fellow passenger does not board the same shared vehicle M of the user when the complaints the candidate of the fellow passenger has received coincide with the complaints that the user has tendency to have (condition 4) even when the traveling routes match on the basis of the first user impression information 138.

The operation plan generating part 126 searches the first user impression information 138 using, for example, a user ID of a first user contained in the ride request 32 as a search key, and specifies a record related to the first user. The operation plan generating part 126 specifies impression that satisfies at least one condition of impression in which the number of times is equivalent to or more than a predetermined number in the specified record, impression in which the a ratio of the number of times corresponding to the impression is equivalent to or more than the predetermined number in the impression included in the record, and impression that is mentioned the largest number of times. The operation plan generating part 126 searches the unified impression information 136 using the user ID of the candidate of the fellow passenger as a search key and when the impression corresponding to the candidate of the fellow passenger coincides with the specified impression, the operation plan generating part 126 considers that the complaints the candidate of the fellow passenger have received matches the complaints that the user has tendency to have and the operation plan generating part 126 determines a combination of fellow passengers such that the candidate of the fellow passenger does not board the shared vehicle M of the user. Since the following processing of determining combination of the fellow passengers is the same as the above-mentioned processing, description thereof will be omitted.

As described above, according to the ride-sharing management device 100 of the variant, it is possible to provide the ride-sharing service that considers users by determining an occupant who boards the same shared vehicle M according to the impressions held by the users in the past on the basis of the first user impression information 138 that integrates the impression information 34 regarding the first user.

While preferred embodiments of the invention have been described and illustrated above, it should be understood that these are exemplary of the invention and are not to be considered as limiting. Additions, omissions, substitutions, and other modifications can be made without departing from the s scope of the present invention. Accordingly, the invention is not to be considered as being limited by the foregoing description, and is only limited by the scope of the appended claims.

What is claimed is:

1. A ride-sharing management device comprising:
an operation plan generating part configured to generate an operation plan for one or more shared vehicles on the basis of a ride request from a user; and
an acquisition part configured to acquire from a first user impression information regarding a second user who has boarded the shared vehicle together with the first user,
wherein the operation plan generating part determines a user who will board the shared vehicle together with the first user on the basis of the impression information acquired by the acquisition part.

2. The ride-sharing management device according to claim 1, wherein the impression information is information generated according to a format that describes complaints with respect to the second user.

3. The ride-sharing management device according to claim 1, wherein the operation plan generating part generates the operation plan on the basis of the impression information.

4. The ride-sharing management device according to claim 1, wherein the operation plan generating part determines a combination such that the first user and the second user do not board the same shared vehicle when the impression information is negative contents equivalent to or more than a first criterion in a case in which the first user boards the shared vehicle.

5. The ride-sharing management device according to claim 1, wherein the operation plan generating part generates the operation plan such that the first user and the second user do not sit on next seats when the impression information is negative contents equivalent to or more than a second criterion in a case in which the first user and the second user board the same shared vehicle together.

6. The ride-sharing management device according to claim 1, further comprising a notification control part configured to perform control for notification that the second user will board the shared vehicle together with the first user when the operation plan generated by the operation plan generating part shows that the first user and the second user will board the same shared vehicle together.

7. A ride-sharing management method performed by a computer, the method comprising:
generating an operation plan for one or more shared vehicles on the basis of a ride request from a user;
acquiring from a first user impression information regarding a second user who has boarded the shared vehicle together with the first user; and
determining a user who boards the shared vehicle together with the first user on the basis of the acquired impression information.

8. A computer-readable non-transient recording medium on which a program is stored and executed by a computer, the program comprising:
generating an operation plan for one or more shared vehicles on the basis of a ride request from a user;
acquiring from a first user impression information regarding a second user who has boarded the shared vehicle together with the first user; and
determining a user who boards the shared vehicle together with the first user on the basis of the acquired impression information.
